(19) United States
(12) Patent Application Publication
(10) Pub. No.: US 2007/0126642 A1
(43) Pub. Date: Jun. 7, 2007

(54) Folding mobile radio device

(76) Inventor: Kenji Sato, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/579,317

(22) PCT Filed: Dec. 7, 2004
(86) PCT No.: PCT/JP04/18210

§ 371 Date: May 16, 2006

(30) Foreign Application Priority Data
Dec. 9, 2003 (JP) 2003-41001

(51) Int. Cl. H01Q 1/24

(52) U.S. Cl. 343/702

(57) ABSTRACT

A folding type mobile radio apparatus whose case is easily miniaturized and that can decrease SAR in a simple structure as compared with a related art example is provided. In a folding type mobile radio apparatus having an upper case and a lower case joined for rotation via a hinge part and an antenna 4 placed on the lower case to the hinge part, a conductor 5 is included on the lower end part side facing the hinge part 3, of an upper circuit board 12 provided in the upper case and the conductor 5 has an elongated thin plate shape as compared with the length of the upper circuit board 12 in the width direction thereof and is connected to ground of the upper circuit board 12 at two parts of both ends in the width direction of the ground of the upper circuit board 12.

### TECHNICAL FIELD

This invention relates to a folding type mobile radio apparatus such as a mobile telephone or a PHS (Personal Handyphone System) with a case that can be folded and in particular to a folding type mobile radio apparatus that can effectively suppress absorption of an electromagnetic wave transmitted from an antenna into a body.

### BACKGROUND ART

In recent years, a mobile telephone has become widespread and various types of mobile phones have been developed. For example, a straight type wherein the casing portion is shaped like a simple rod, a folding type mobile phone of the type wherein when it is not used, upper and lower cases can be folded for enhancing the portability and protecting a liquid crystal display section and moreover preventing trouble of operating an operation key by mistake, and the like are known.

By the way, for an antenna installed on a mobile phone, it is known that generally when the antenna is used, as the antenna is placed away from the body of the user, the absorption amount of an electromagnetic wave into the human body decreases and the radiation efficiency is increased. On the other hand, weight reduction and sliming of the mobile phone are fostered from the viewpoints of design, portable convenience, etc.; particularly, as the mobile phone is slimed, the antenna of the mobile phone tends to be brought close to the body of the user, and the absorption amount of the electromagnetic wave into the human body increases.

At present, in various countries, specific absorption rate (SAR) is used as an index representing the electromagnetic wave absorption amount into the human body and a regulation is demanded so as to limit the SAR within a given value; the possibility that the regulation value may be exceeded grows because of sliming.

By the way, in the folding type mobile phone described above, as the place where the antenna is installed, mainly any of the top or bottom end part of the upper case, a hinge part, or the top or bottom end part of the lower case is possible from convenience of the physical space, etc., in addition to providing antenna performance.

Moreover, to place the SAR within the regulation value, it is desirable that the antenna should be installed in the hinge part, on the lower case side, etc., at a distance from the body of the user as much as possible among the antenna installation places described above. However, even if the antenna is installed at such a place, it is feared that the SAR cannot be placed within the regulation value because of sliming the case, etc., as described above. Then, taking some steps for decreasing the SAR is demanded.

For example, a mobile phone as shown in FIG. 6 is proposed as a mobile phone in a related art taking steps for decreasing the SAR.

As shown in the figure, the mobile phone includes an antenna 101 and a ground conductor 102 and a conductive flat plate 103 provided with a slit operating as the antenna 101. The conductive flat plate 103 electrically short-circuits one end of the ground conductor 102 in the length direction thereof and opens an opposite end, thereby suppressing a high-frequency current flowing into the ground conductor 102 and decreasing the electromagnetic wave radiation amount (for example, refer to patent document 1).

Patent document 1: JP-A-2002-94311

### DISCLOSURE OF THE INVENTION

Problems to be Solved by the Invention

In the mobile phone in the related art described in patent document 1, however, as shown in FIG. 6, the size of about a quarter of the wave length is required as length H between the open end and the short-circuited end of the conductive flat plate 103 and thus it is difficult to miniaturize the mobile phone in the direction connecting the open end and the short-circuited end (up and down direction in the figure).

Moreover, the mobile phone in the related art as described in patent document 1 is applied to a mobile phone wherein the casing portion wholly is of the rod-shaped (straight) type, and does not assume a folding type mobile phone; development of effective SAR decreasing technique is demanded for the folding type mobile phone. Further, for the mobile phone of the type wherein two or more different frequency bands can be used, a problem of complicating the structure of a conductive flat plate also occurs.

It is therefore an object of the invention to provide a folding type mobile radio apparatus whose case is easily miniaturized and that can decrease the SAR in the simple structure as compared with the related art example.

Means for Solving the Problems

According to the invention, there is provided a folding type mobile radio apparatus having an upper case and a lower case joined for rotation via a hinge part and an antenna placed on the upper or lower case to the hinge part, wherein an elongated conductor is included on an end part side facing the hinge part, of a circuit board provided in the upper or lower case where the antenna is not installed and wherein the conductor is connected to ground of the circuit board at two parts of both ends in the width direction of the ground of the circuit board or at one part on an opposite side to a feeding point of the antenna with respect to the width direction of the circuit board.

According to the configuration, it is made possible to decrease the SAR with a radio apparatus having folding cases rather than a rod-like (straight) case as in the related art example. Moreover, the elongated conductor is included along the width direction on the end part side to the hinge part close to the antenna, of the circuit board provided in the upper or lower case where the antenna is not installed, so that the communication terminal can be miniaturized without the need for a large space. Further, the conductor does not require a slit, etc., and thus the SAR can be decreased in the simpler structure than that in the related art example.

According to the invention, there is provided a folding type mobile radio apparatus having an upper case and a lower case joined for rotation via a hinge part and an antenna placed on the lower case to the hinge part, wherein an elongated conductor is included on a lower end part side of an upper circuit board provided in the upper case facing the hinge part and wherein the conductor is connected to ground of the upper circuit board at two parts of both ends in the width direction of the ground of the upper circuit board or at one part on an opposite side to a feeding point of the antenna with respect to the width direction of the upper circuit board.

Likewise, according to the configuration, it is made possible to decrease the SAR with a radio apparatus having folding cases rather than a rod-like (straight) case as in the related art example. Moreover, the elongated conductor is included along the width direction on one end part side to the hinge part close to the antenna, of the upper circuit board provided in the upper case where the antenna is not installed, so that the communication terminal can be miniaturized without the need for a large space. Further, the conductor does not require a slit, etc., and thus the SAR can be decreased in the simpler structure than that in the related art example.

According to the invention, there is provided a folding type mobile radio apparatus having an upper case and a lower case joined for rotation via a hinge part and an antenna placed on the hinge part, wherein an elongated conductor is included on a lower end part side of an upper circuit board provided in the upper case facing the hinge part and wherein the conductor is connected to ground of the circuit board at two parts of both ends in the width direction of the ground of the circuit board or at one part on an opposite side to a feeding point of the antenna with respect to the width direction of the circuit board.

Likewise, according to the configuration, it is made possible to decrease the SAR with a radio apparatus having folding cases rather than a rod-like (straight) case as in the related art example. Moreover, the elongated conductor is included along the width direction on one end part side to the hinge part close to the antenna, of the upper circuit board provided in the upper case where the antenna is not installed, so that the communication terminal can be miniaturized without the need for a large space. Further, the conductor does not require a slit, etc., and thus the SAR can be decreased in the simpler structure than that in the related art example.

In the folding type mobile radio apparatus of the invention, the conductor is integrated with the ground of the upper or lower circuit board to which the conductor is connected, and is used as a part of the ground of the circuit board.

According to the configuration, physical connection of the conductor and the circuit board, for example, work of soldering, etc., becomes unnecessary, so that the number of manufacturing steps can be reduced.

In the folding type mobile radio apparatus of the invention, the conductor is formed of a conductive material having a roughly U shape or a rough L shape.

The conductor is thus formed as a simple shape, whereby it is made possible to decrease the SAR in the further simple structure as compared with the related art example.

Advantages of the Invention

According to the invention, there can be provided the folding type mobile radio apparatus which uses the conductor having the elongated thin plate shape as compared with the length of the circuit board in the width direction thereof as the SAR decreasing technique and can demonstrate high antenna performance without the need for a large occupation space for improving the antenna performance and is suitable for miniaturization.

### BRIEF DESCRIPTION OF THE DRAWINGS

FIG. 1 (A) is an external perspective view of a folding type mobile phone according to a first embodiment of the invention and FIG. 1 (B) is a schematic representation to show the internal electric configuration;

FIG. 2 is a schematic representation to show the placement relationship among an antenna, a conductor, an upper case, and the like in the invention;

FIG. 3 (A) is a schematic representation to show an SAR distribution of the folding type mobile phone according to the first embodiment of the invention and FIG. 3 (B) is a schematic representation to show an SAR distribution of the folding type mobile phone in a related art;

FIG. 4 (A) is a schematic representation to show the placement relationship of a conductor wherein an electronic part is placed in the lower part of an upper circuit board according to the first embodiment of the invention and FIG. 4 (B) is a schematic representation to show a modified example;

FIG. 5 (A) is a schematic representation to show the internal electric configuration of a folding type mobile phone according to a second embodiment of the invention and FIG. 5 (B) is a schematic representation to show the current distribution; and

FIG. 6 is a schematic representation to show the electric configuration of a folding type mobile phone in a related art.

### DESCRIPTION OF REFERENCE NUMERALS

1 Upper case
11 Display section
12 Upper circuit board
2 Lower case
21 Lower circuit board
22 Feeding point
3 Hinge part
31 Flexible cable (FPC)
4 Antenna
5 Conductor
6 Camera (electronic part)
7 Conductor
D Current density
I High-frequency current
S SAR distribution

### BEST MODE FOR CARRING OUT THE INVENTION

Embodiments of the invention will be discussed in detail with reference to the accompanying drawings.

### FIRST EMBODIMENT

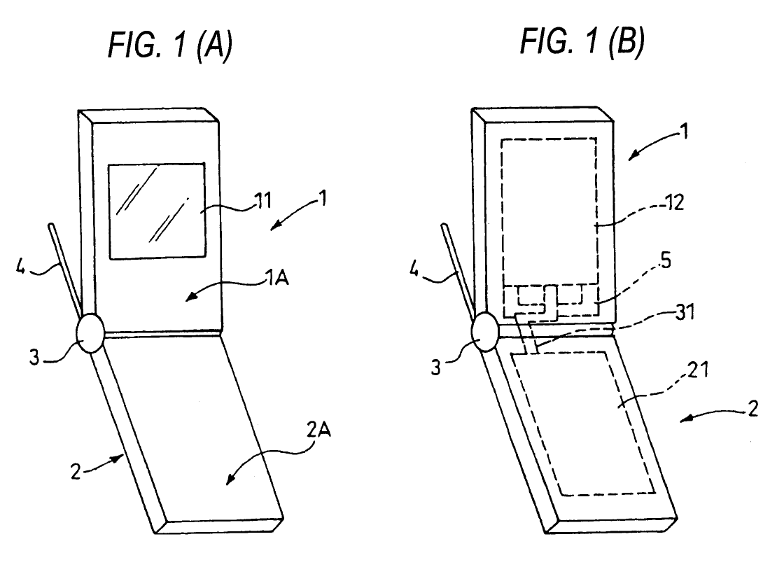

FIG. 1 shows a folding type mobile phone according to a first embodiment of the invention. This folding type mobile phone has an upper case 1 and a lower case 2 connected via a hinge part 3 and an antenna 4 placed on the lower case 2 in the vicinity of the hinge part 3. The antenna 4 is shaped like a monopole and performs unbalanced feeding into the ground of the lower case 2. The antenna 4 may exist outside or inside the lower case 2.

As shown in FIG. 1 (A), an LCD (Liquid Crystal Display) implementing a display section 11 is installed on one face (main face 1A) of the upper case 1 opposed to one face (main face 2A) of the lower case 2 when the folding type mobile phone is folded, and the upper case 1 incorporates an upper circuit board 12 (see FIG. 1 (B)) mounting circuit parts not shown. The upper circuit board 12 is electrically connected to a lower circuit board 21 described later by a flexible cable 31, for example, an FPC (flexible printed circuit).

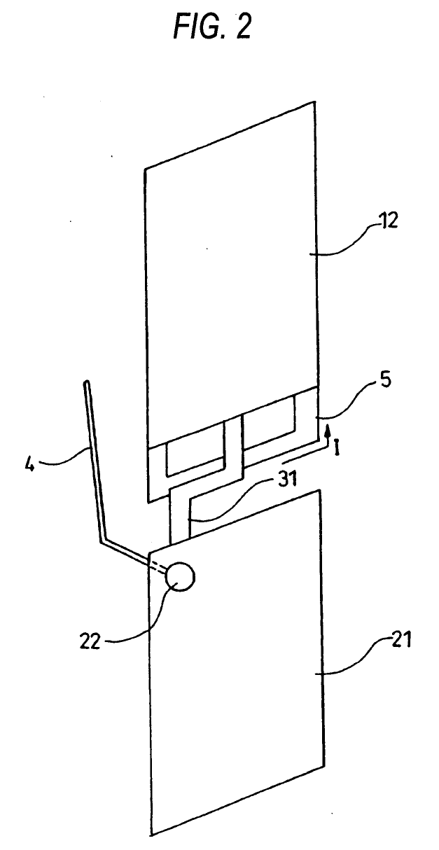

On the other hand, as shown in FIG. 1 (A), the lower case 2 has an operation section not shown on the main face 2A and incorporates a lower circuit board 21 (see FIG. 1 (B)) mounting circuit parts not shown. The lower circuit board 21 is connected to the antenna 4 via a feeding point 22 (see FIG. 2).

The antenna 4 radiates an electromagnetic wave in radio communications with a base station not shown. To effectively suppress absorption of the electromagnetic wave into a human body, a conductor 5 is connected (at two parts in total) to both end sides of ground positioned on the lower end part side of the upper circuit board 12 to the antenna (namely, to the hinge part 3), as shown in FIG. 1 (B).

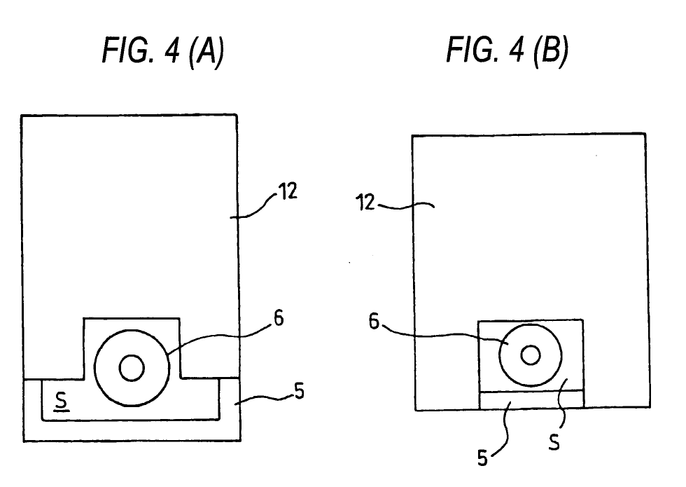

The conductor 5 forms a SAR decreasing member. As shown in FIGS. 1 and 4 (A), the conductor is formed of a conductive material shaped like a narrow plate having a roughly U shape and is placed in the lower part of the upper case 1 in the proximity of the antenna 4. The conductor 5 is placed in the lower part of the upper case 1 as in the embodiment, but a similar advantage can be provided if the conductor 5 is placed in the hinge part 3. In the embodiment, the conductor has a roughly U shape as described above, but may be shaped like a straight rod (I shape) if the upper circuit board 12 is formed roughly like an U shape, as shown in FIG. 4 (B).

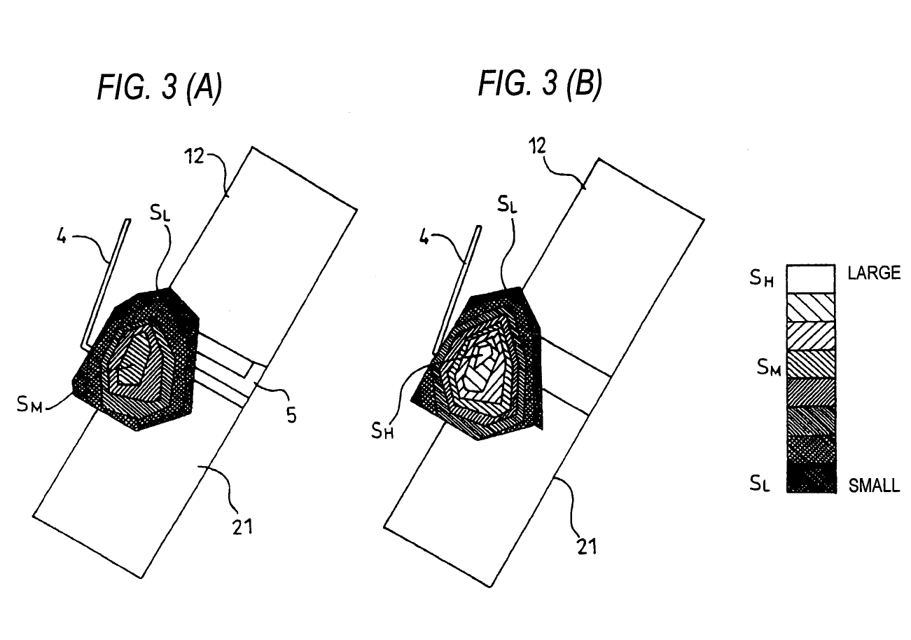

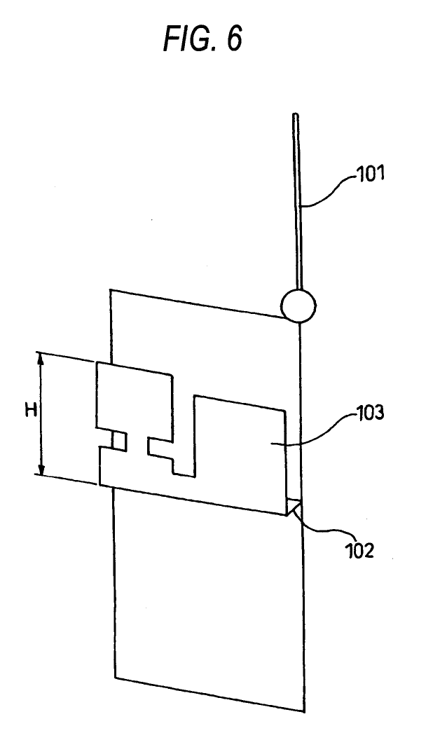

Next, the operation of the folding type mobile phone according to the embodiment will be discussed. To begin with, in FIG. 2, when an electromagnetic wave is radiated from the antenna 4, a high-frequency current flows into the lower circuit board 21, propagates through the flexible cable 31, and flows into the upper circuit board 12. Here, if it is assumed that the conductor 5 does not exist, the place where high-frequency current (density) D is the strongest is in the vicinity of the feeding point 22. If the high-frequency current (density) thus concentrates on one part, the SAR value increases and in the related art example shown in FIG. 6, the SAR distribution becomes as shown in FIG. 3 (B).

On the other hand, if the conductor 5 exists as in the embodiment shown in FIG. 2, an induced current is induced in the conductor 5 in the presence of the high-frequency current in the vicinity of the feeding point 22, and high-frequency current I flows into the conductor 5. Here, the conductor 5 is connected at both ends to the ground of the upper circuit board 12 and thus is at the same potential at both ends. Consequently, the high-frequency current I induced in the conductor 5 attempts to uniformly flow through the top of the conductor 5. Thus, the current I induced in the conductor 5 from the vicinity of the feeding point 22 flows out into the right opposite to the left near to the feeding point 22 and the high-frequency current on the left end side of the conductor 5 near to the feeding point 22 is scattered.

Therefore, in the embodiment, it was acknowledged that the maximum value of the SAR distribution (S_{M}) is decreased as shown in FIG. 3 (A) as compared with the related art example wherein the maximum value of the SAR distribution with the conductor 5 not provided becomes S_{H} (see FIG. 3 (B)). That is, in FIG. 3, the contour display showing more fringes shows the SAR distribution and indicates that the region nearer to the center part (in the vicinity of the feeding point) is the region where the electromagnetic wave is absorbed into a human body at higher rate, namely, the SAR (specific absorption rate) value is higher. From FIGS. 3 (A) and (B), it is seen that the SAR value in the embodiment shown in FIG. 3 (A) is decreased more than that in the related art example shown in FIG. 3 (B). That is, when an experiment (simulation) concerning the current (density) distribution was conducted by the inventors involved in the invention, it was acknowledged that the SAR can be decreased about 20% as the conductor 5 is provided as in the embodiment.

The SAR decreasing rate is equal regardless of whether the conductor 5 is placed between the antenna 4 and the flexible cable 31 or is placed on the opposite side of the antenna 4 relative to the flexible cable 31.

In the embodiment, the folding type mobile phone using one frequency band for radio communications has been described. However, for example, for a folding type mobile phone (communication terminal) of the type wherein two or more different frequency bands can be used, the SAR decreasing effect can also be provided by adding the conductors 5 corresponding to the frequency bands.

In the embodiment, the whole shape of the upper circuit board 12 containing the conductor 5 is shaped roughly like a rectangle as shown in FIG. 2. However, if an electronic part such as a camera 6 is placed in the lower part of the upper case 1 as shown in FIG. 4, it is also made possible to decrease the SAR.

That is, for the mobile phone with a camera, if the structure wherein the conductor 5 is connected to the ground face at both ends of the upper circuit board 12 in the width direction thereof is used intact and the camera 6 is placed in a space S between the conductor 5 and the lower end part of the upper circuit board 12, the SAR can be decreased as in the embodiment. In this case, if the two connection positions of the conductor 5 to the upper circuit board 12 are at a longer distance from each other, the high-frequency current can be more scattered and the SAR decreasing effect increases.

In the embodiment, the conductor 5 has the roughly U shape as described above, but may be shaped like a straight rod (rough I shape) if the upper circuit board 12 is formed roughly like an U shape, as shown in FIG. 4 (B). That is, in this case, it is also made possible to decrease the SAR if an electronic part such as the camera 6 is placed in the space S as in FIG. 4 (A).

Further, soldering, a connection connector, etc., is used for connecting the upper circuit board 12 and the conductor 5. However, if the conductor 5 is manufactured physically integral with the upper circuit board 12 and is caused to operate as the ground face of the upper circuit board 2, it is also effective for decreasing the SAR.

### SECOND EMBODIMENT

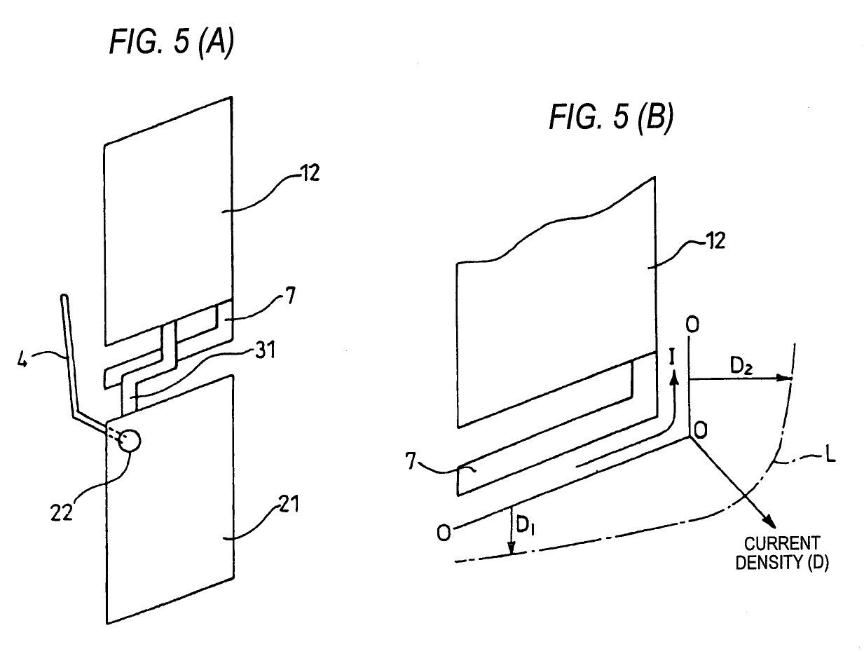

Next, a second embodiment of the invention will be discussed with FIG. 5. Parts identical with those of the first embodiment are denoted by the same reference numerals in the second embodiment and will not be discussed again. In the second embodiment, a conductor 7 for suppressing electromagnetic waves absorbed into a human body is formed of a conductive material shaped like a narrow plate having a rough L shape as in FIG. 5 (A). The conductor 7 is positioned on the end face (lower end side) of an upper circuit board 12 to an antenna 4 (to a hinge part 3) and is connected to ground of the upper circuit board 12 at an opposite position (in FIG. 5 (A), on the right end side) to the position corresponding to a feeding point 22 with respect to the width direction of the upper circuit board 12.

The conductor 7 is connected to the lower end part of the upper circuit board 12. However, a similar SAR effect can be provided regardless of whether the conductor 7 is placed in the lower part of an upper case 1 in the vicinity of the antenna 4 or in the hinge part 3. Further, the conductor 7 may be placed in and connected to the upper circuit board 12 not only at a position at a distance from the antenna 4 as in the embodiment, but also at a position near to the antenna 4 with respect to a flexible cable 31.

Next, the operation of the folding type mobile phone according to the embodiment will be discussed. In FIG. 5, when an electromagnetic wave is radiated from the antenna 4, a strong high-frequency current flows in the vicinity of the feeding point 22 as in the first embodiment. However, the conductor 7 exists in the proximity of the feeding point 22 and thus the high-frequency current is induced into the conductor 7.

Here, the end part of the conductor 7 to the feeding point 22 is an open end and the impedance is very high. On the other hand, the end part of the conductor 7 opposite to the feeding point 22 is a short-circuited end and thus the impedance is very low. Accordingly, induced high-frequency current I flows from the part where the impedance is high to the part where the impedance is low, as shown in FIG. 5 (B). Consequently, the current concentrated on the vicinity of the feeding point 22 is scattered to the opposite side to the feeding point 22.

Here, when an experiment (simulation) to examine the current (density) distribution state as in FIG. 3 was conducted by the inventors to check a decrease in the SAR about the folding type mobile phone according to the embodiment, it was acknowledged that an about 20% SAR decrease can be accomplished. Particularly, as shown in FIG. 5 (B), it was also found that as the open end of the conductor 7 is brought closer to the antenna 4, the high-frequency current I is more induced into the conductor 7 and it can be expected that the SAR will be more decreased. In FIG. 5 (B), dashed line L is an envelope indicating the distribution state of equal current (density) along the length direction of the conductor 7, and D₁, and D₂ indicate each the current strength at the part.

Further, if the conductor 7 is integrated with the upper circuit board 12 and is caused to operate as the ground face of the upper circuit board 12, it is also effective for decreasing the SAR.

It is to be understood that the invention is not limited to the specific embodiments described above and that the invention can be embodied in various forms without departing from the spirit and the scope of the invention. That is, the invention may be applied if a folding type mobile radio apparatus includes an antenna in the proximity of a hinge part and therefore the SAR decrease effect can be provided if the folding type mobile radio apparatus is of the type wherein an antenna is included in a hinge part, for example. While the invention has been described in detail with reference to the specific embodiments, it will be obvious to those skilled in the art that various changes and modifications can be made without departing from the spirit and the scope of the invention.

The present application is based on Japanese Patent Application No. 2003-410001 filed on Dec. 9, 2003, which is incorporated herein by reference.

### INDUSTRIAL APPLICABILITY

The folding type mobile radio apparatus of the invention has the advantages that it is easy to miniaturize the case and moreover that the SAR can be decreased in the simple structure as compared with the related art example. Particularly, the invention is useful for various folding type mobile radio apparatuss with an antenna attached to a hinge part or a case to a hinge part, for example, a mobile phone, a PDA (Personal Digital Assistant), etc.

1. A folding type mobile radio apparatus, comprising:
an upper case and a lower case coupled for rotation via a hinge part; and
an antenna arranged on the upper case or the lower case to the hinge part,
wherein an elongated conductor is provided on an end part side facing the hinge part, of a circuit board provided in the upper case or the lower case where the antenna is not installed; and
wherein the conductor is connected to ground of the circuit board at two parts of both ends in the width direction of the ground of the circuit board or at one part on an opposite side to a feeding point of the antenna with respect to the width direction of the circuit board.

2. A folding type mobile radio apparatus, comprising:
an upper case and a lower case coupled for rotation via a hinge part; and
an antenna arranged on the lower case to the hinge part,
wherein an elongated conductor is provided on a lower end part side of an upper circuit board provided in the upper case facing the hinge part; and
wherein the conductor is connected to ground of the upper circuit board at two parts of both ends in the width direction of the ground of the upper circuit board or at one part on an opposite side to a feeding point of the antenna with respect to the width direction of the upper circuit board.

3. A folding type mobile radio apparatus, comprising:
an upper case and a lower case coupled for rotation via a hinge part; and
an antenna provided on the hinge part,
wherein an elongated conductor is provided on a lower end part side of an upper circuit board provided in the upper case facing the hinge part; and
wherein the conductor is connected to ground of the circuit board at two parts of both ends in the width direction of the ground of the circuit board or at one part on an opposite side to a feeding point of the antenna with respect to the width direction of the circuit board.

4. The folding type mobile radio apparatus as set forth in claim 1, wherein the conductor is integrated with the ground of the circuit board to which the conductor is connected, and serves as a part of the ground of the circuit board.

5. The folding type mobile radio apparatus as set forth in claim 1, wherein the conductor is formed of a conductive material having a substantially U shape or a substantially L shape.

6. The folding type mobile radio apparatus as set forth in claim 2, wherein the conductor is integrated with the ground of the upper circuit board to which the conductor is connected, and serves as a part of the ground of the circuit board.

7. The folding type mobile radio apparatus as set forth in claim 3, wherein the conductor is integrated with the ground of the upper circuit board to which the conductor is connected, and serves as a part of the ground of the circuit board.

8. The folding type mobile radio apparatus as set forth in claim 2, wherein the conductor is formed of a conductive material having a substantially U shape or a substantially L shape.

9. The folding type mobile radio apparatus as set forth in claim 3, wherein the conductor is formed of a conductive material having a substantially U shape or a substantially L shape.
